(19) United States
(12) Patent Application Publication
(10) Pub. No.: US 2003/0169496 A1
(43) Pub. Date: Sep. 11, 2003

(54) 3D-eyeglass for seeing two dimensional video picture in three dimension

(76) Inventor: Oscar Bilbao Varona, Loma Linda, CA (US)

Correspondence Address: Elizabeth Varona Cordero, 26035 Brookmere Avenue, Loma Linda, CA, 92354, US

(21) Appl. No.: 10/094,160

(22) Filed: Mar. 11, 2002

(51) Int. Cl. G02B 27/22

(52) U.S. Cl. 359/462; 359/466

(57) ABSTRACT

The present invention relates particularly to a 3D-EYEGLASS for seeing two-dimensional video movie pictures in three dimension straight from standard television.

### FIELD OF INVENTION

The present invention relates in general to a 3D-EYEGLASS more particularly to a revolutionary 3D-EYEGLASS for seeing two-dimensional video movie pictures in three-dimension straight from standard television.

### BACKGROUND OF INVENTION

Conventional 3D viewing consists generally of a stereoscopic video movie picture recordings. During playback, special Viewers are needed to separate the left and right eye as follows:

1) Different colors and filters for the left and the right eye are used.

2) Different polaroid glasses for the left and the right eye are used.

3) Electronic shutters for the left and right eye are used.

The mind of the viewer then resolves the video movie pictures of the left and right eye in three-dimensional video movie pictures.

Conventional 3D viewing are specialized, expensive, and are not readily available straight from standard television, which are drawbacks.

### SUMMARY OF INVENTION

The present invention seeks to overcome these drawbacks with the object therefore of making a revolutionary 3D-EYEGLASS wherein a concave lens is used having inherent axial symmetry whose surface refracts or bends incoming video movie light rays (video movie pictures) into two symmetrical identical, coherent, and magnified video movie pictures—for the left eye and right eye. The viewer's mind then sees the two-dimensional video movie pictures in three-dimension straight from standard television.

### BRIEF DESCRIPTION OF THE DRAWING

These and other features and advantages of the present invention will be more apparent in the following detailed description thereof taken in conjunction with the apprehended drawings wherein:

FIG. 1 is the pictorial view of the 3-piece 3D-EYEGLASS made up of plastics which are transparent, clear, high impact resistant, solid, resilient, tinted, and light material.

FIG. 2 is the pictorial view of the 2-piece 3D-EYEGLASS made up of plastics which are transparent, clear, high impact resistant, solid, resilient, tinted, and light material.

FIG. 3 is the pictorial view of the relationship between the object, the concave lens, and the eyes.

### DETAILED DESCRIPTION OF THE DRAWING

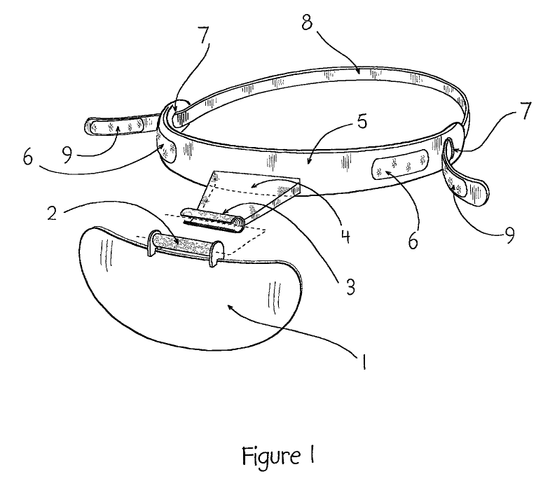

Referring now to the drawings in detail where like numerals designate the same parts where there is shown in FIG. 1 the 3-piece 3D-EYEGLASS comprising of a concave lens 1 with an integral cylinder 2 which can be engaged snugly or disengaged to the tube clip 3 and is flippable. The tube clip 3 is integral to the forehead rest cap 4 and to the forehead rest 5. The forehead rest 5 includes two holes 7 and two Velcro strips 6. The headband 8 includes two Velcro strips 9.

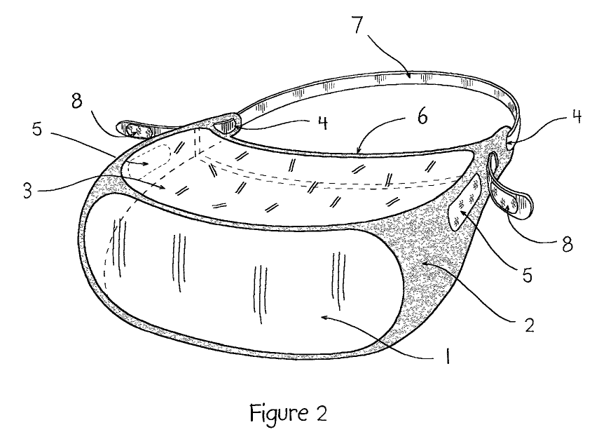

Shown in FIG. 2 is the 2-piece 3D-EYEGLASS generally comprising of a concave lens 1 with an integral body 2, integral forehead rest cap 3, integral forehead rest 6. The body 2 includes two holes 4 and two Velcro strips 5. The headband 7 includes two Velcro strips 8.

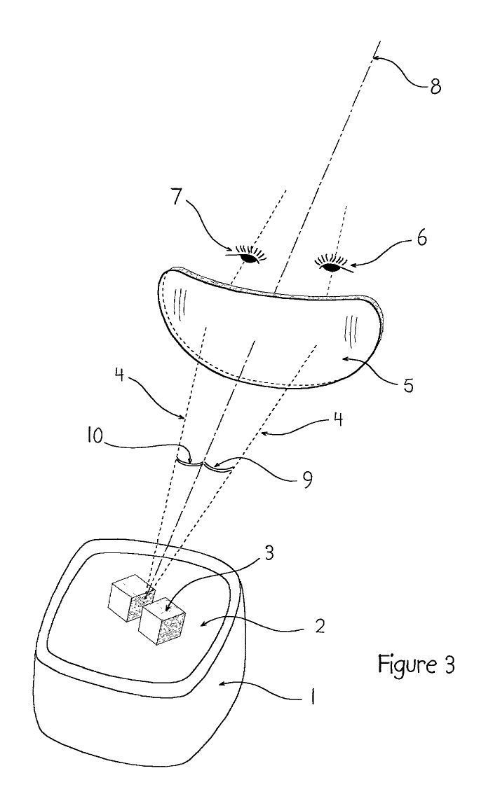

In FIG. 3 is shown the viewer's eye's focusing on an object, a two-dimensional video movie pictures on the screen 2 of the standard television 1.

If the faces of the viewer, the concave lens 5 and the television 1 are parallel and in-line (co-axial) with axial symmetry 8 the viewer becomes one-eyed seeing the same identical pictures with symmetry and coherence.

As the video movie picture scenes change from one scene to another scene within the eye's persistence of vision, the viewer's mind sees a two-dimensional video movie pictures in three-dimension straight from standard television.

What is claimed is:

1. A revolutionary 3D-EYEGLASS comprising a concave lens with inherent axial symmetry whose surface refracts or bends incoming video movie light rays (video movie pictures) into two symmetrical, coherent (in-steps), identical, magnified video movie light rays (video movie pictures) for the left eye and for the right eye for seeing two-dimensional video movie pictures in three-dimension straight from standard television.

2. A revolutionary 3D-EYEGLASS in claim 1 wherein all parts are molded plastics and can be easily mass produced.

3. A revolutionary 3D-EYEGLASS in claim 1 wherein the concave lens can easily be engaged snugly or disengaged and is flippable.

4. A revolutionary 3D-EYEGLASS in claim 1 which can be a 3-piece type or 2-piece type.
